(19) United States
(12) Patent Application Publication
(10) Pub. No.: US 2025/0341122 A1
(43) Pub. Date: Nov. 6, 2025

(54) LOCK WITH SLIDING AND RETRACTING LOCKING ELEMENTS

(71) Applicant: Amesbury Industries, Inc., Edina, MN (US)

(72) Inventor: Douglas John Criddle, Sioux Falls, SD (US)

(73) Assignee: Amesbury Industries, Inc., Edina, MN (US)

(21) Appl. No.: 19/191,331

(22) Filed: Apr. 28, 2025

Related U.S. Application Data
(60) Provisional application No. 63/641,531, filed on May 2, 2024.

(51) Int. Cl. E05C 5/00

(52) U.S. Cl. CPC E05C 5/00

(57) ABSTRACT

A sliding door lock includes a housing, a locking element, and a drive assembly configured to extend and retract the locking element in a transverse direction and slide the locking element along a longitudinal axis while extended. The drive assembly includes a cam and a slide mechanism. Upon rotation of the cam, the slide mechanism linearly translates along the longitudinal axis. The drive assembly also includes a retractor supported at least partially within the slide mechanism. When the slide mechanism linearly translates along the longitudinal axis, the retractor during a first movement portion of the slide mechanism slides along the transverse direction to extend or retract the locking element from the housing. During a second movement portion of the slide mechanism, the retractor maintains position in the transverse direction to slide the locking element along the longitudinal axis while extended.

### CROSS-REFERENCE TO RELATED APPLICATION(S)

This application claims the benefit of priority to U.S. Provisional Application No. 63/641,531, filed May 2, 2024, the entire disclosure of which is incorporated herein by reference in its entirety.

### INTRODUCTION

In the patio door/sliding glass door manufacturing industry, the most commonly used mortise lock is the single-point lock. A single locking element (e.g., a hook) is usually incorporated into the mortise lock device. Due to their small size and simple construction, manufacture of single hook locks is generally cost effective. Single-point locks suffer the drawback, however, of being somewhat easily broken or disengaged by a fairly insignificant force, thus defeating the purpose for which the lock is intended.

Multi-point locks include two or more locking elements that pivot out of one or more lock housings to engage with keeper elements on a door frame. Multi-point locks offer increased security over single-point locks that include only a single locking element. While more secure, multi-point locks are typically larger than single-point locks and more expensive to manufacture, due to the increased number of complex components utilized in the lock mechanism. Also, most sliding door manufacturers only provide an opening in the door for the smaller, single-point mortise locks.

### SUMMARY

In an aspect, the technology relates to a sliding door lock including: a housing having a front face and an interior cavity, the housing defining a longitudinal axis parallel to the front face; at least one locking element disposed at the front face; and a drive assembly disposed at least partially within the interior cavity of the housing and configured to extend and retract the at least one locking element in a transverse direction relative to the longitudinal axis and slide the at least one locking element along the longitudinal axis while extended, the drive assembly including: a cam rotatably supported by the housing; a slide mechanism operationally coupled to the cam, wherein upon rotation of the cam, the slide mechanism is adapted to linearly translate along the longitudinal axis; and a retractor supported at least partially within the slide mechanism and coupled to the at least one locking element and to the housing, wherein when the slide mechanism linearly translates along the longitudinal axis, the retractor during a first movement portion of the slide mechanism slides along the transverse direction to extend or retract the at least one locking element from the housing and during a second movement portion of the slide mechanism maintains position in the transverse direction to slide the at least one locking element along the longitudinal axis while extended.

In an example, the first movement portion and the second movement portion of the slide mechanism are sequential with one another. In another example, the housing includes a pair of sides, each side defining a dog leg slot, and the retractor having a pin at least partially received within the dog leg slot. In still another example, the dog leg slot includes a first section parallel to the longitudinal axis and a second section angled relative to the longitudinal axis, and the first movement portion of the slide mechanism occurs while the pin is within the second section of the dog leg slot and the second movement portion of the slide mechanism occurs while the pin is within the first section of the dog leg slot. In yet another example, the slide mechanism includes a channel elongated in a direction orthogonal to the longitudinal axis, the pin of the retractor disposed within the channel of the slide mechanism.

In an example, the dog leg slot is adjacent a rear face of the housing. In another example, the retractor includes a biasing spring configured to bias the at least one locking element in the extended position. In still another example, the slide mechanism includes a threaded boss configured to extend at least partially from the housing.

In another aspect, the technology relates to a sliding door lock including: a housing having a front face and a pair of sides forming an interior cavity, the housing defining a longitudinal axis parallel to the front face, wherein each side defines a dog leg slot; at least one locking element disposed at the front face; and a drive assembly disposed at least partially within the interior cavity of the housing and configured to extend and retract the at least one locking element in a transverse direction relative to the longitudinal axis and slide the at least one locking element along the longitudinal axis while extended, the drive assembly including: a cam rotatably supported by the housing; a slide mechanism operationally coupled to the cam, wherein upon rotation of the cam, the slide mechanism is adapted to linearly translate along the longitudinal axis; and a retractor supported by the slide mechanism and coupled to the at least one locking element, the retractor having a pin that is received at least partially within the dog leg slot, wherein when the slide mechanism linearly translates along the longitudinal axis, the pin being in a first section of the dog leg slot moves the retractor along the transverse direction to extend and retract the at least one locking element and the pin being in a second section of the dog leg slot retains the retractor relative to the transverse direction to slide the at least one locking element along the longitudinal axis while extended.

In an example, the first section of the dog leg slot is parallel to the longitudinal axis and the second section of the dog leg slot is angled relative to the longitudinal axis. In another example, the cam is rotatable between at least a first operating position whereby the at least one locking element is retracted and a second operating position whereby the at least one locking element is extended and longitudinally locked, and about a third of the rotation of the cam is configured to move the at least one locking element towards the extended position and about two-thirds of the rotation of the cam is configured to slide the extended at least one locking element towards the longitudinally locked position. In still another example, the slide mechanism includes a channel elongated in a direction orthogonal to the longitudinal axis, the pin of the retractor disposed within the channel of the slide mechanism. In yet another example, the channel is rectangular in shape.

In an example, the retractor is substantially T-shaped with the pin disposed in a base leg. In another example, the retractor includes a biasing spring configured to bias the at least one locking element in the extended position. In still another example, the slide mechanism includes a threaded boss configured to extend at least partially from the housing.

In another aspect, the technology relates to a sliding door lock including: a housing defining a dog leg slot; a cam rotatably mounted in the housing and movable between at least a first operating position and a second operating position; a slide mechanism adapted to linearly translate in the housing along a longitudinal axis, wherein the slide mechanism comprises a slot extending substantially orthogonal to the longitudinal axis; a pin coupled to the cam and being slidably engaged with the slot of the slide mechanism, wherein rotation of the cam moves the slide mechanism between at least a first position and a second position; at least one locking element coupled to the slide mechanism and adapted to move with the slide mechanism; an overcenter spring for biasing the pin, wherein the force exerted on the pin by the overcenter spring forces the cam into both the first operating position and the second operating position; and a retractor supported at least partially within the slide mechanism, the retractor includes a retractor pin that is slidably received at least partially within the dog leg slot of the housing, wherein when the slide mechanism moves between the first position and the second position via rotation of the cam, the retractor at least partially transversely slides relative to the slide mechanism via the retractor pin so as to move the at least one locking element between an extended locked configuration and a retracted unlocked configuration.

In an example, the slide mechanism includes a threaded boss. In another example, the retractor further includes a bias spring supported on the retractor pin, the bias spring configured to allow the at least one locking element to depress when in the extended locked configuration and in an anti-slam configuration. In still another example, the at least one locking element includes a pair of locking elements.

### BRIEF DESCRIPTION OF THE DRAWINGS

There are shown in the drawings, examples that are presently preferred, it being understood, however, that the technology is not limited to the precise arrangements and instrumentalities shown.

FIG. 1 is a perspective view of a prior art multi-point sliding door lock.

FIGS. 2 and 3 are perspective views of an exemplary multi-point sliding door lock and in accordance with the inventive principles described herein.

FIG. 4 is an exploded, perspective view of the multi-point sliding door lock shown in FIGS. 2 and 3.

FIG. 5 is a longitudinal cross-sectional view of the multi-point sliding door lock shown in FIGS. 2 and 3.

FIG. 6 is a schematic view of the multi-point sliding door lock in a locked configuration.

FIG. 7 is a schematic view of the multi-point sliding door lock in an unlocked configuration.

FIG. 8 is a schematic view of the multi-point sliding door lock and in a position between the locked configuration and the unlocked configuration.

FIGS. 9-10 are perspective views of a slide mechanism body of the multi-point sliding door lock.

FIGS. 11-12 are perspective views of a retractor body of the multi-point sliding door lock.

### DETAILED DESCRIPTION

A sliding door lock with a retractable locking element provides the locking performance of an enlarged protruding head linearly sliding into engagement with a reduced thickness opening of a keeper, while also being configured to retract when unlocked and so as to reduce undesirable user contact and snagging clothing or other objects. Additionally, the locking element retracting when unlocked is more aesthetically pleasing than a lock that is unlocked and with the locking element still extended. The sliding door lock described below has a housing and one or more locking elements configured to extend and retract while also being able to linearly slide relative to the housing for locking engagement with the keeper. The drive assembly of the locking element includes a slide mechanism that linearly slides within the housing. A retractor is supported by the slide mechanism and is coupled to the locking element and the housing. When the slide mechanism slides within the housing, the retractor is configured to extend or retract the locking element during a first movement portion of the slide mechanism. Then with a second movement portion of the slide mechanism, the retractor is configured to maintain the extension of the locking element for locking engagement with the keeper and in a longitudinal sliding movement.

When the locking element is extended, the retractor allows for the locking element to be selectively depressed into the housing and facilitate an anti-slam configuration. The retractor may include a biasing spring for the locking element so that the locking element is biased towards the extended position after depression during the anti-slam. In examples, the slide mechanism includes a threaded boss to allow the addition of a shootbolt or an attachment point for other remote lock points of the sliding door.

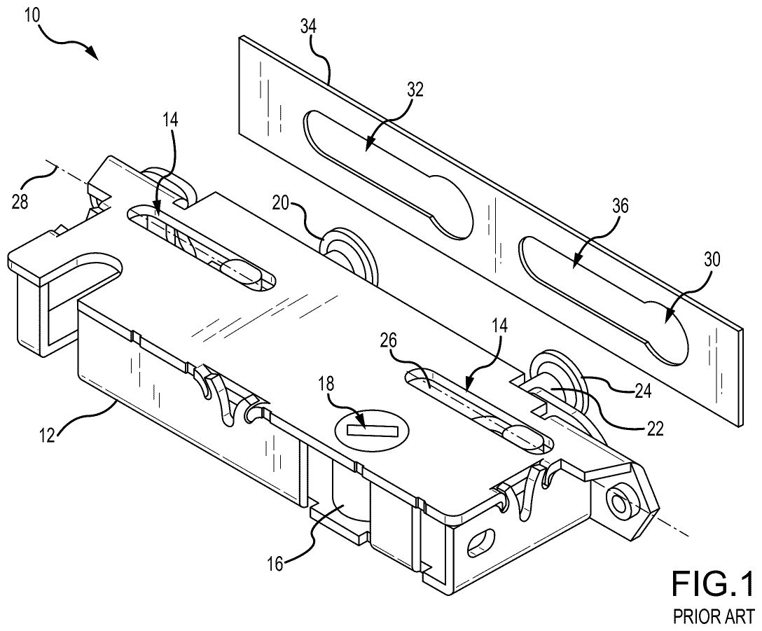

FIG. 1 is a perspective view of a prior art multi-point sliding door lock 10. The multi-point sliding door lock 10 is described in detail in U.S. Pat. No. 8,939,474 which is incorporated herein by reference in its entirety. The multi-point sliding door lock 10 includes a housing 12 defining one or more projection slots 14 along the sides. An actuation cam 16 is rotatably supported by the housing 12 and defines a slot 18 for receiving a tailpiece from a thumbturn or a key cylinder. A pair of locking elements 20 project from the housing 12 and include a shaft 22 and an enlarged head 24. The shaft 22 is coupled to a slide mechanism 26 that is disposed within the housing 12 and the slide mechanism 26 engages with the actuation cam 16.

In operation, rotation of the actuation cam 16 slides the slide mechanism 26 within the housing 12 and along a longitudinal axis 28. Movement of the slide mechanism 26 facilitates corresponding longitudinal movement of the locking elements 20. As such, when a sliding door is closed, the head 24 of the locking element 20 can be received in an enlarged portion 30 of an opening 32 of a keeper 34. Then the locking elements 20 can slide within the opening 32 of the keeper 34 to a reduced portion 36 for locking engagement via rotation of the actuation cam 16.

Additionally, the locking elements 20 are biased in an outward direction and as illustrated relative to the housing 12 and the slide mechanism 26. This biasing of the locking elements 20 facilitate an anti-slam mechanism that limits or eliminates damage that would otherwise occur to the multi-point sliding door lock 10 or the keeper 34 if the locking elements 20 are closed against the keeper 34 and without being in the proper position for extending through the opening 32. The anti-slam mechanism allows for the locking elements 20 to retract into the housing 12 when a force orthogonal relative to the longitudinal axis 28 is applied to the locking elements 20.

In this example, while the anti-slam mechanism of the locking elements 20 reduces or eliminates damage when slamming against the keeper 34 or other object, the locking elements 20 are in an extended position relative to the housing 12 in both a locked and unlocked configuration. Thus, the locking elements 20 extend and project from the housing 12 even when the sliding door is open and unlocked. Accordingly, the extended locking elements 20 may catch on users of the sliding door, or the user's clothing, objects, and the like that are passing though the open sliding door and with the extended locking elements 20 projecting therefrom. Additionally, it may be aesthetically unpleasing for the locking elements 20 to be extended in an unlocked configuration. It is thereby desirable for a multi-point sliding door lock that can retract the locking elements at least in the unlocked configuration and so that users and their clothing/objects are prevented or restricted from catching on the locking elements when passing though the open, unlocked sliding door.

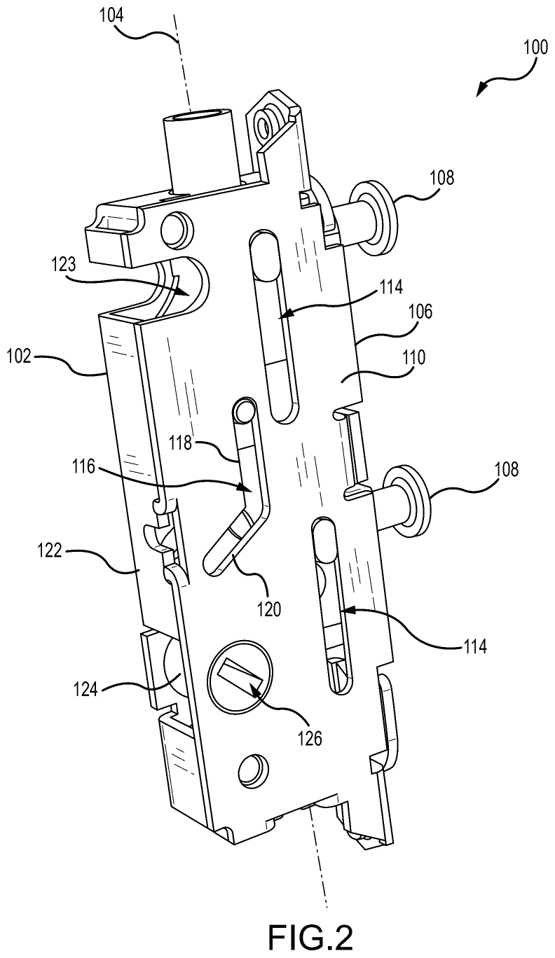

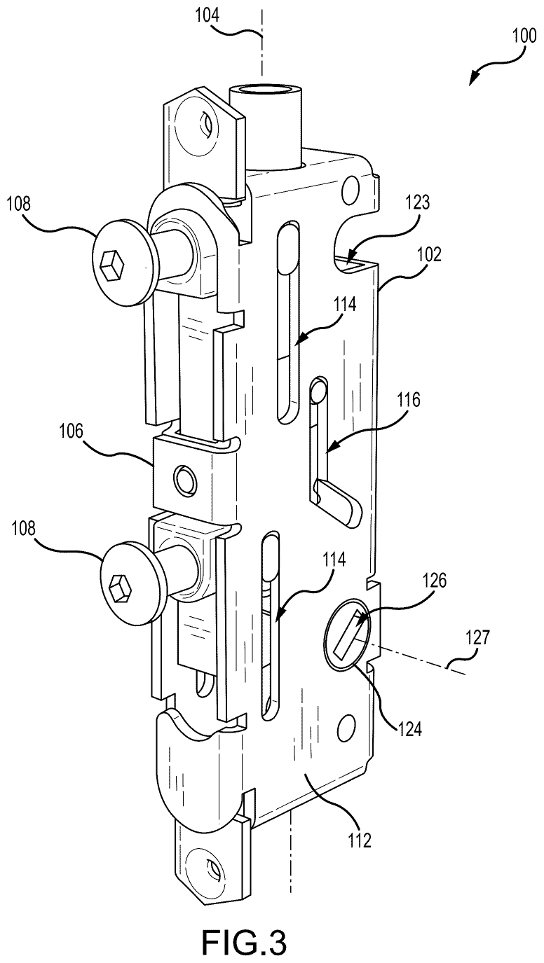

FIGS. 2 and 3 are perspective views of an exemplary multi-point sliding door lock 100. Referring concurrently to FIGS. 2-3, the sliding door lock 100 includes a housing 102 that defines a longitudinal axis 104. The housing 102 has a front face 106 that a pair of locking elements 108 extend therefrom. The front face 106 extends parallel to the longitudinal axis 104. While a pair of locking elements 108 are illustrated, it is appreciated that a single locking element may be utilized, or more than two locking elements may be utilized, as required or desired. In the example, the front face 106 is configured to be aligned and positioned on the edge of the sliding door (not illustrated).

Extending from the front face 106, the housing 102 has opposing first and second parallel sides 110, 112. Each side 110, 112 includes one or more projection slots 114. The projection slots 114 are elongated along the longitudinal axis 104 and disposed toward the front face 106. Additionally, each side 110, 112 includes a retractor slot 116. The retractor slot 116 is a dog leg shape with a first section 118 that is elongated along the longitudinal axis 104 and parallel with the projection slots 114, and a second section 120 that is disposed at an angle other than orthogonal relative to the longitudinal axis 104 and extending in a direction towards a rear face 122. The retractor slot 116 is positioned between the projection slots 114 and the rear face 122 while being adjacent to the rear face 122. In the example, the first section 118 has a shorter longitudinal length than the projection slots 114. In an aspect, the first section 118 is about two-thirds the length of the projection slots 114. The second section 120 may extend longitudinally about one-third the length of the projection slots 114, while also extending transversely the extension distance of the locking elements 108. As such, the angle of the second section 120 relative to the longitudinal axis 104 may be between about 40° to 70°. In an aspect, the angle may be about 55°.

The housing 102 defines an interior cavity 123 that houses the drive components of the sliding door lock 100. In the example, the housing 102 rotatably supports an actuation cam 124 at least partially within the interior cavity 123 and that defines a slot 126 accessible from either side 110, 112. The slot 126 is shaped and sized to receive a tailpiece from a thumbturn, key cylinder, or the like and that operates the sliding door lock 100. The actuation cam 124 is rotatable around a rotation axis 127 that is orthogonal to the longitudinal axis 104.

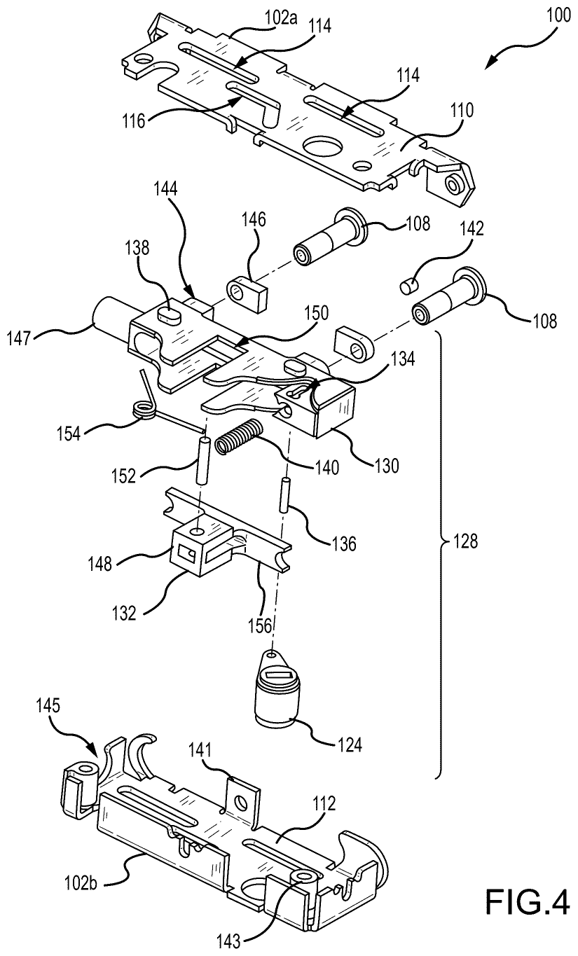

FIG. 4 is an exploded, perspective view of the sliding door lock 100. The housing 102 may be formed with a two-piece body 102a, 102b that couples together and forms the interior cavity 123 (shown in FIGS. 2 and 3) housing a drive assembly 128. The drive assembly 128 is configured to extend and retract the locking elements 108 in a transverse direction relative to the longitudinal axis 104 (shown in FIGS. 2 and 3) and slide the locking elements 108 along the longitudinal axis 104 while extended. Each body 102a, 102b has the respective side 110, 112 that defined the projection slots 114 and the retractor slot 116.

The drive assembly 128 includes the actuation cam 124, a slide mechanism 130, and a retractor 132. The actuation cam 124 couples to a linkage pin slot 134 defined within the slide mechanism 130 via a pin 136. Upon rotation of the actuation cam 124 between two rotation operating positions, the pin 136 slides within the pin slot 134 and the slide mechanism 130 slides within the housing 102 and along the longitudinal axis 104 (shown in FIG. 2) between at least two positions. The slide mechanism 130 includes one or more projections 138 that are engaged with and slide within the projection slots 114 of the housing 102. An overcenter spring 140 is disposed within the linkage pin slot 134 and provides a biasing force on the actuation cam 124 and towards either a locked or an unlocked configuration of the locking elements 108 based on the rotational position of the actuation cam 124 and the sliding position of the slide mechanism 130.

The housing bodies 102a, 102b may be coupled together with a rivet 142 through corresponding tabs 141 at the front face 106 (shown in FIGS. 2 and 3). Additionally, the housing 102 may include post supports 143 at the interior corners of the interior cavity 123 for structural support. An end of the housing 102 defines an opening 145 allowing access into the interior cavity 123. In the example, the slide mechanism 130 includes a threaded boss 147 extending along the longitudinal axis 104. The threaded boss 147 is configured to extend and retract from the housing 102 via the opening 145 and allows the addition of a shootbolt or an attachment point for other remote lock points (not shown) of the sliding door. In other examples, the threaded boss 147 may be any other connection structure facilitating the operational coupling of a remote lock point to the slide mechanism 130.

The slide mechanism 130 includes bores 144 that are positioned at the front face 106 of the housing 102 and that receive the locking elements 108 so that the locking elements 108 may extend and retract from the front face of the housing 102. A hardened locking element plate 146 is disposed within the slide mechanism 130 and coupled to the end of the locking element 108 so as to retain the locking elements 108 to the slide mechanism 130. The locking element plate 146 allows the locking element 108 to transversely slide relative to the slide mechanism 130 and also prevents the locking element 108 from being pulled from the bore 144.

The retractor 132 is supported at least partially within the slide mechanism 130 and is coupled to the locking elements 108 and the housing 102. In the example, the retractor 132 has a substantially T-shaped body with a single leg 148 that is slidably engaged with a corresponding channel 150 defined in the slide mechanism 130. As such, the retractor 132 can slide with the slide mechanism 130 along the longitudinal axis 104 and also slide relative to the slide mechanism 130 and in an orthogonal direction relative to the longitudinal axis 104. The leg 148 is substantially rectangular in shape and receives a retractor pin 152 therein. The retractor pin 152 is slidably received within the retractor slots 116 of the housing 102. The retractor pin 152 also supports one or more bias springs 154 that biases the locking elements 108 in an extended position, while also enabling the locking elements 108 to be selectively depressed and forming an anti-slam mechanism. The bias spring 154 may be disposed at least partially within the leg 148 with distal ends that extend out from the leg 148 and to the locking element plate 146.

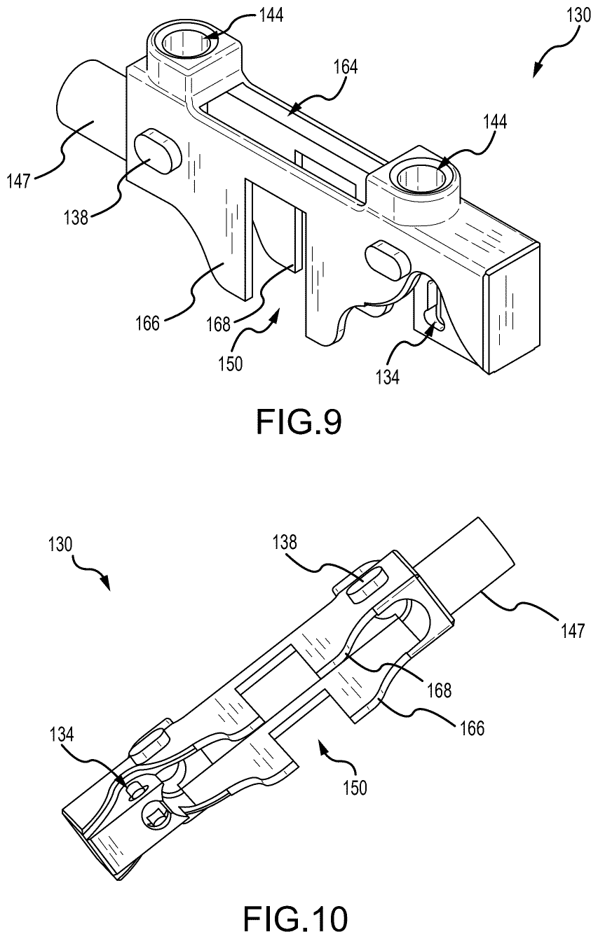

The T-shaped body of the retractor 132 also includes a cross-member 156. The ends of the cross-member 156 are coupled between the slide mechanism 130 and the locking element plates 146. The ends of the cross-member 156 face the locking elements 108 and in some examples directly touch the locking elements 108. However, the locking elements 108 may transversely slide relative to the ends of the cross-member 156 for the anti-slam mechanism. The slide mechanism 130 and the retractor 132 are described in more detail below and in reference to FIGS. 9-12.

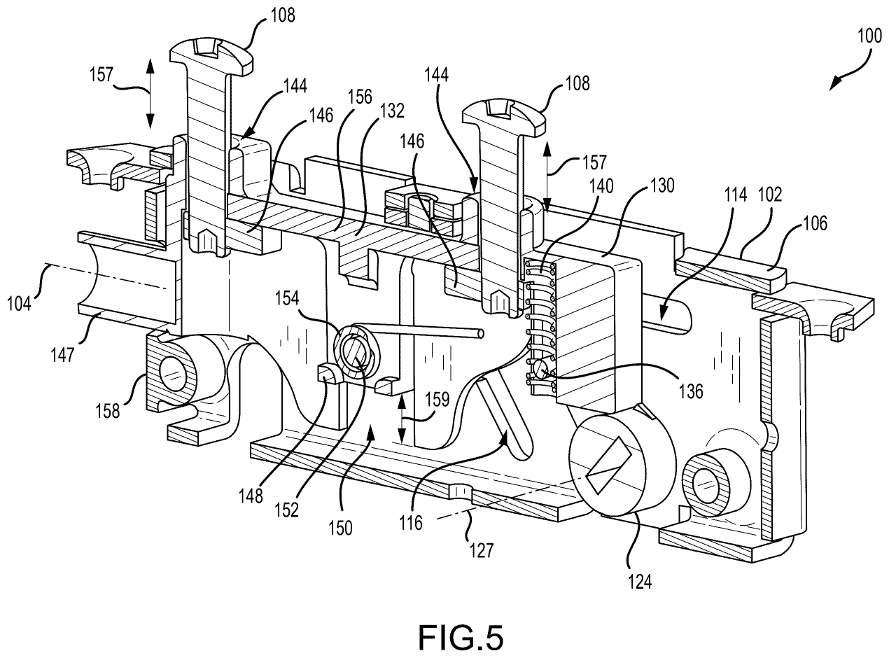

FIG. 5 is a cross-sectional view of the sliding door lock 100. Certain components are described above and are not necessarily described further. As illustrated in FIG. 5, the slide mechanism 130 is disposed proximate a top end 158 of the housing 102 and so that the threaded boss 147 extends therefrom along the longitudinal axis 104. Additionally, the locking elements 108 are in their extended most position relative to the front face 106 of the housing 102 and relative to a transverse direction 157 that is orthogonal to the longitudinal axis 104 and the rotation axis 127 of the actuation cam 124. This configuration of the sliding door lock 100 is a locked configuration and whereby the locking elements 108 are configured to engage with the corresponding keeper (not shown).

In the locked configuration, the locking elements 108 may be individually depressed in the transverse direction 157 as the anti-slam mechanism. The locking element plate 146 being on an opposite side of the retractor 132 from the bore 144 of the slide mechanism 130 is configured to move with the locking element 108 and the bias spring 154 biases each locking element plate 146 and locking element 108 to the extended position individually. The locking element plate 146 and locking element 108 can slide and be depressed in the transverse direction 157 relative to the retractor 132 and slide mechanism 130 when in the locked configuration for the anti-slam mechanism.

In the example, when the sliding door lock 100 is in the locked configuration, the retractor 132 is positioned towards the bores 144 of the slide mechanism 130. That is, the cross-member 156 of the retractor 132 is adjacent the bores 144 and the leg 148 is in a fully recessed position within the channel 150 of the slide mechanism 130 and so that an offset gap 159 is formed with the far end of the slide mechanism 130 in the transverse direction 157.

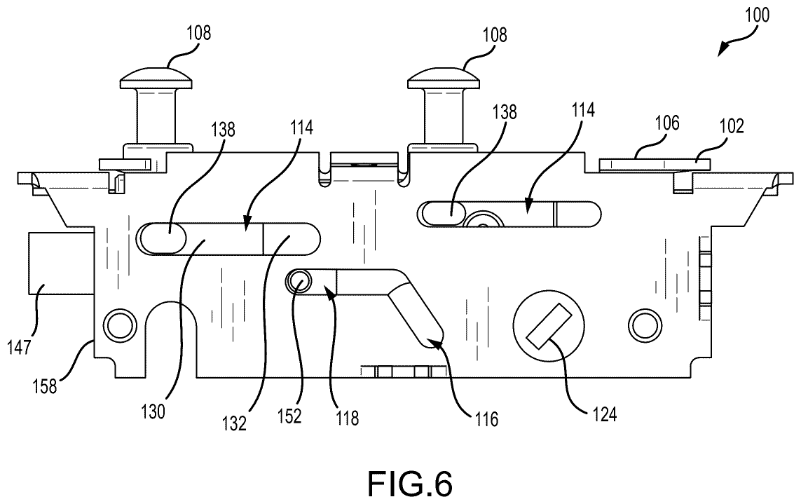

Upon rotation of the actuation cam 124 around the rotation axis 127, the locking elements 108 are configured to move towards an unlocked configuration as described further below in reference to FIGS. 6-8.

FIG. 6 is a schematic view of the sliding door lock 100 in a locked configuration. In the locked configuration, and as described above, the locking elements 108 are in an extended position relative to the housing 102 and for engagement with a corresponding keeper. The locking elements 108 are also positioned towards the top end 158 of the housing 102. The extension and longitudinal position of the locking elements 108 is at least partially controlled by the position of the slide mechanism 130 within the housing 102. In the locked configuration, the slide mechanism 130 is positioned towards the top end 158 of the housing 102 in a first position and so that the projections 138 are disposed at the top ends of the projection slots 114. Additionally, the retractor pin 152 is disposed at the top end of the first section 118 of the retractor slot 116 of the housing 102. This position of the retractor pin 152 positions the retractor 132 towards the front face 106 of the housing 102 and within the slide mechanism 130 with the locking elements 108 biased in the extended position. Additionally, when the slide mechanism 130 is in the first position and the locked configuration, the threaded boss 147 extends from the top end 158 of the housing 102.

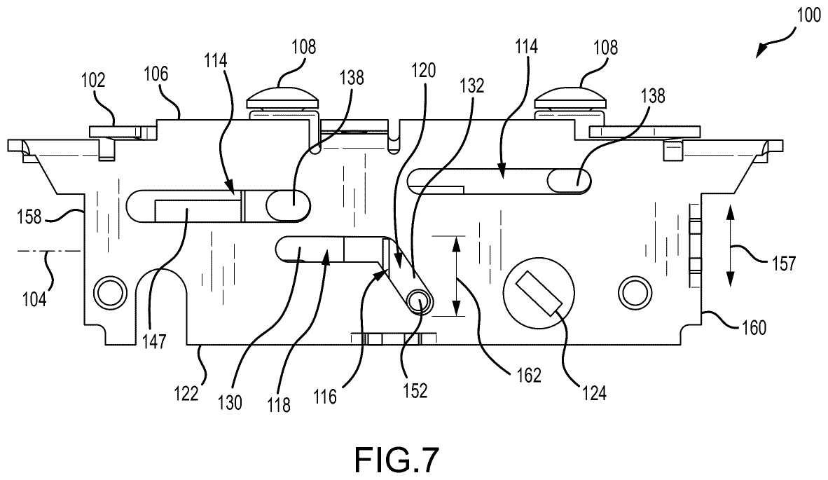

FIG. 7 is a schematic view of the sliding door lock 100 in an unlocked configuration. In the unlocked configuration, the locking elements 108 are in a retracted position relative to the front face 106 of the housing 102. The locking elements 108 are also positioned towards a bottom end 160 of the housing 102. Upon rotation of the actuation cam 124 between rotational positions, the actuation cam 124 slides the slide mechanism 130 along the longitudinal axis 104 within the housing 102. As the slide mechanism 130 slides towards the bottom end 160 of the housing 102 and to a second position within the housing 102, the projections 138 slide within the projection slots 114 and to a bottom end of the slots.

Additionally, movement of the slide mechanism 130 causes the retractor pin 152 to move within the retractor slot 116. When the retractor pin 152 is within the first section 118 of the retractor slot 116, the retractor 132 longitudinally slides with the slide mechanism 130 and with no movement in the transverse direction 157. When the retractor pin 152 is within the second section 120 of the retractor slot 116, the retractor 132 slides along the longitudinal axis 104 with the slide mechanism 130 and also moves towards the rear face 122 of the housing 102 and in the transverse direction 157. Moving the retractor 132 in the transverse direction 157 direction pulls and retracts the locking elements 108 into the housing 102 so that the likelihood of users or objects catching on the locking elements 108 when passing though the sliding door is reduced or eliminated and when the sliding door lock 100 is unlocked. Additionally, by retracting the locking elements 108 when the lock is unlocked, lock aesthetics are increased.

The retractor 132 supports the bias spring 154 (shown in FIG. 4) so that the bias spring 154 also moves with the retractor 132 so as to maintain biasing of the locking elements 108 during movement between the locked and unlocked positions. As the cross-member 156 (shown in FIG. 4) of the retractor 132 moves in the transverse direction 157, the locking element plate 146 (shown in FIG. 4) coupled to the locking elements 108 is engaged, and thereby, retracts the locking element 108 into the housing 102 when in the unlocked configuration. This configuration of the retractor 132 while retracting the locking elements 108 together and in a coupled manor, still enables the locking elements 108 to independently depress for the anti-slam feature described above and when moving from the locked configuration. In the example, a transverse distance 162, parallel to the transverse direction 157, which the second section 120 extends at least partially defines the retraction distance of the locking elements 108 when in the unlocked configuration. In aspects, the locking elements 108 may fully retract, or only partially retract in the unlocked configuration, and as required or desired.

Additionally, when the slide mechanism 130 is in the second position and the unlocked configuration, the threaded boss 147 is retracted relative to the top end 158 of the housing 102. In other examples, the threaded boss 147 may be only partially extended from the top end 158 when in the unlocked configuration.

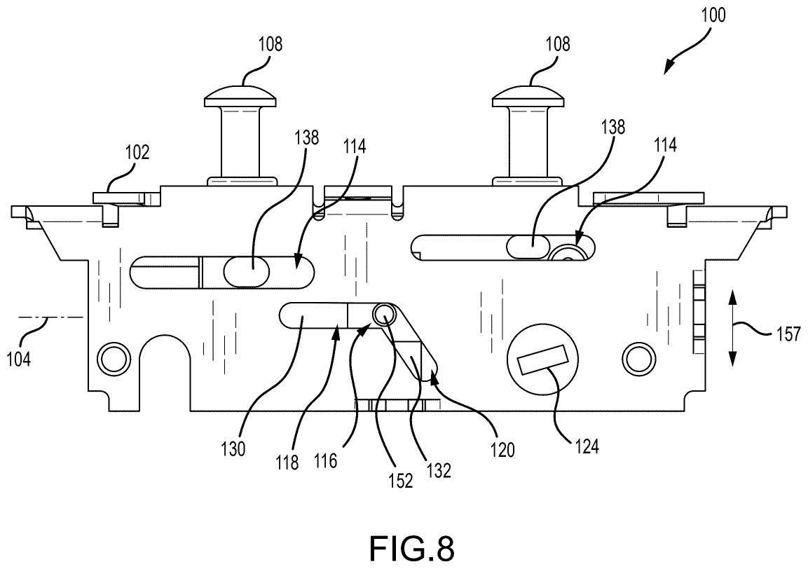

FIG. 8 is a schematic view of the sliding door lock 100 and in a position between the locked configuration (shown in FIG. 6) and the unlocked configuration (shown in FIG. 7). In this intermediate position, the slide mechanism 130 and actuation cam 124 is between the first and second positions described above, and as such the projections 138 are between the ends of the projection slots 114. When the slide mechanism 130 moves between the locked configuration and the unlocked configuration, the slide mechanism 130 only slides relative to the longitudinal axis 104 within the housing 102 and does not move in the transverse direction 157.

Additionally, in this intermediate position, the retractor pin 152 is at the dog leg elbow of the retractor slot 116. At this location, the locking elements 108 are extended relative to the housing 102 and so as to be able to be extended into the keeper prior to sliding towards the locked configuration. Additionally, each locking element 108 is independently depressible in the anti-slam feature because the biasing spring moves with the retractor 132. From the elbow of the retractor slot 116, when the retractor 132 via the retractor pin 152 moves within the second section 120, the retractor 132 is configured to move longitudinally and transversely during the sliding movement portion of the slide mechanism 130 between the locked and unlocked positions. This movement of the retractor 132 extends and retracts the locking elements 108. When the retractor 132 via the retractor pin 152 moves within the first section 118, the retractor 132 is configured to only move longitudinally during the sliding movement portion of the slide mechanism 130 between the locked and unlocked positions. This movement of the retractor 132 maintains position in the transverse direction and only longitudinally slides the locking elements 108 while extended. During the locking and unlocking operations of the sliding door lock 100, the extension/retraction movement of the locking elements 108 occurs sequentially with the longitudinal sliding movement of the locking elements 108.

In the example, when moving the sliding door lock 100 from the unlocked configuration towards the locked configuration, the first ⅓ of the throw of the actuation cam 124 will raise the locking elements 108, then the remaining ⅔ of the throw will engage the keeper. Because a portion of the throw will raise the locking elements 108 and the locking elements 108 are raised while the slide mechanism 130 is longitudinally moved, the enlarged portions of the openings in the keeper are elongated so as to capture this travel movement of the locking elements 108 and the enlarged heads.

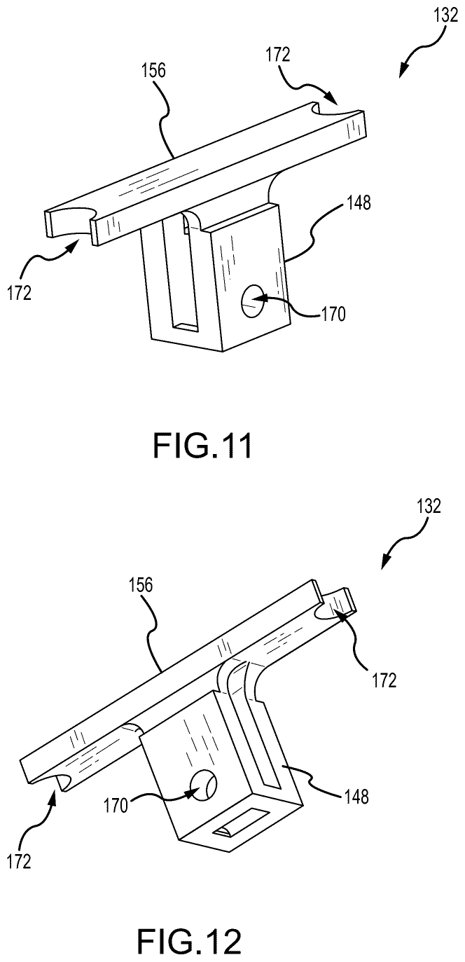

FIGS. 9-10 are perspective views of the slide mechanism 130 of the sliding door lock 100 (shown in FIGS. 2-8). The slide mechanism 130 is sized and shaped to be at least partially disposed within the housing 102 (shown in FIGS. 2 and 3) and to receive and support the retractor 132 (shown in FIGS. 11 and 12). The slide mechanism 130 is also configured to allow the retractor 132 to transversely slide therein. In the example, a front opening 164 is defined in the slide mechanism 130 and facilitates access to the retractor 132. The opening 164 is longitudinally bounded by the bores 144 of the slide mechanism 130 and that support the locking elements 108 (shown in FIGS. 2 and 3). The opening 164 and the bores 144 are configured to be disposed at the front face of the housing 102.

The slide mechanism 130 includes a pair of sidewalls 166, 168 that are spaced apart from one another. The retractor 132 is disposed between the sidewalls 166, 168. The projections 138 are disposed on an outer surface of the sidewalls 166, 168. In the example, the projections 138 are longitudinally aligned with the bores 144. The channel 150 is defined within each sidewall 166, 168 and disposed between the bores 144 and the projections 138. In the example, the channel 150 is elongated in the transverse direction. In the example, the channel 150 is rectangular in shape and sized to allow the retractor pin 152 (shown in FIG. 4) and at least a portion of the retractor 132 to extend therein and move in the transverse direction relative to the slide mechanism 130. At the bottom end of the slide mechanism 130, the pin slot 134 is defined and parallel to the channel 150 at each sidewall 166, 168.

Opposite of the pin slot 134, the slide mechanism 130 includes the threaded boss 147 integrated therein. The threaded boss 147 moves with the slide mechanism 130 and is disposed proximate the top end 158 of the housing 102 (shown in FIG. 5). The threaded boss 147 is configured to allow the coupling of a shootbolt or an attachment point for other lock points that are actuated by the slide mechanism 130 via a threaded rod (e.g., a ¼ inch threaded rod). The threaded boss 147 may extend from the housing 102 when in the locked configuration. The slide mechanism 130 may be formed as a cast metal component for strength. In an aspect, the bottom end of the slide mechanism 130 may additionally or alternatively include a threaded boss for another remote lock point and as required or desired.

FIGS. 11-12 are perspective views of the retractor 132 of the sliding door lock 100 (shown in FIGS. 2-8). The retractor 132 is a T-shape and includes the leg 148 and the cross-member 156. The leg 148 is rectangular in shape and is partially hollow. An aperture 170 is defined through the leg 148 and for supporting the retractor pin 152 (shown in FIG. 4). The partially hollow leg 148 is sized to support the bias spring 154 (shown in FIG. 4) and allow at least a portion of the bias spring 154 to extend outward therefrom. The leg 148 is received within the channels 150 of the slide mechanism 130 (both shown in FIGS. 9-10) and can transversely slide within the channels 150.

The distal ends of the cross-member 156 are recessed 172 so as to at least partially receive a portion of the locking elements 108 (shown in FIG. 4). The recesses 172 allow the locking elements 108 to transversely slide relative to the retractor 132 for the anti-slam feature. The distal ends of the cross-member 156 are also positioned between the slide mechanism 130 and the locking element plates 146 (shown in FIG. 4) so that the cross-member 156 is used to retract the locking elements 108 upon transverse movement of the retractor 132.

The sliding door lock described above includes retractable locking elements that provide the locking performance of an enlarged protruding head linearly sliding into engagement with a reduced thickness opening of a keeper while also being configured to retract when unlocked and so as to reduce undesirable user contact and snagging clothing or other objects. Additionally, lock aesthetics are increased in the unlocked configuration. The sliding door lock has a housing, and one or more locking elements configured to extend and retract while also being able to linearly slide relative to the housing for locking engagement with the keeper. The drive assembly of the locking elements include a slide mechanism that linearly slides within the housing. A retractor is supported by the slide mechanism and is coupled to the locking elements and the housing. When the slide mechanism slides within the housing, the retractor is configured to extend or retract the locking elements during a first movement portion of the slide mechanism. Then with a second movement portion of the slide mechanism, the retractor is configured to maintain the extension of the locking elements for locking engagement with the keeper. The retractor has a retractor pin that engages with a dog-leg slot on the housing so as to translate the sliding movement of the slide mechanism to transverse movement of the locking elements.

When the locking elements are extended, the retractor allows for the locking elements to be selectively retracted into the housing and facilitate an anti-slam configuration. The retractor may include a biasing spring for the locking elements so that the locking elements are biased towards the extended position after retraction during the anti-slam. In examples, the slide mechanism includes a threaded boss to allow the addition of a shootbolt or an attachment point for other remote lock points of the sliding door.

The materials utilized in the manufacture of the multi-point sliding door lock described herein may be those typically utilized for door hardware, e.g., zinc, steel, aluminum, brass, stainless steel, etc. Molded plastics, such as PVC, polyethylene, etc., may be utilized for the various components. Material selection for most of the components may be based on the proposed use of the sliding door. Appropriate materials may be selected for components used on particularly heavy panels, as well as on components subject to certain environmental conditions (e.g., moisture, corrosive atmospheres, etc.).

While there have been described herein what are to be considered exemplary and preferred examples of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A sliding door lock comprising:
a housing having a front face and an interior cavity, the housing defining a longitudinal axis parallel to the front face;
at least one locking element disposed at the front face; and
a drive assembly disposed at least partially within the interior cavity of the housing and configured to extend and retract the at least one locking element in a transverse direction relative to the longitudinal axis and slide the at least one locking element along the longitudinal axis while extended, the drive assembly including:
a cam rotatably supported by the housing;
a slide mechanism operationally coupled to the cam, wherein upon rotation of the cam, the slide mechanism is adapted to linearly translate along the longitudinal axis; and
a retractor supported at least partially within the slide mechanism and coupled to the at least one locking element and to the housing, wherein when the slide mechanism linearly translates along the longitudinal axis, the retractor during a first movement portion of the slide mechanism slides along the transverse direction to extend or retract the at least one locking element from the housing and during a second movement portion of the slide mechanism maintains position in the transverse direction to slide the at least one locking element along the longitudinal axis while extended.

2. The sliding door lock of claim 1, wherein the first movement portion and the second movement portion of the slide mechanism are sequential with one another.

3. The sliding door lock of claim 1, wherein the housing includes a pair of sides, each side defining a dog leg slot, and the retractor having a pin at least partially received within the dog leg slot.

4. The sliding door lock of claim 3, wherein the dog leg slot includes a first section parallel to the longitudinal axis and a second section angled relative to the longitudinal axis, and wherein the first movement portion of the slide mechanism occurs while the pin is within the second section of the dog leg slot and the second movement portion of the slide mechanism occurs while the pin is within the first section of the dog leg slot.

5. The sliding door lock of claim 3, wherein the slide mechanism includes a channel elongated in a direction orthogonal to the longitudinal axis, the pin of the retractor disposed within the channel of the slide mechanism.

6. The sliding door lock of claim 3, wherein the dog leg slot is adjacent a rear face of the housing.

7. The sliding door lock of claim 1, wherein the retractor includes a biasing spring configured to bias the at least one locking element in the extended position.

8. The sliding door lock of claim 1, wherein the slide mechanism includes a threaded boss configured to extend at least partially from the housing.

9. A sliding door lock comprising:
a housing having a front face and a pair of sides forming an interior cavity, the housing defining a longitudinal axis parallel to the front face, wherein each side defines a dog leg slot;
at least one locking element disposed at the front face; and
a drive assembly disposed at least partially within the interior cavity of the housing and configured to extend and retract the at least one locking element in a transverse direction relative to the longitudinal axis and slide the at least one locking element along the longitudinal axis while extended, the drive assembly including:
a cam rotatably supported by the housing;
a slide mechanism operationally coupled to the cam, wherein upon rotation of the cam, the slide mechanism is adapted to linearly translate along the longitudinal axis; and
a retractor supported by the slide mechanism and coupled to the at least one locking element, the retractor having a pin that is received at least partially within the dog leg slot, wherein when the slide mechanism linearly translates along the longitudinal axis, the pin being in a first section of the dog leg slot moves the retractor along the transverse direction to extend and retract the at least one locking element and the pin being in a second section of the dog leg slot retains the retractor relative to the transverse direction to slide the at least one locking element along the longitudinal axis while extended.

10. The sliding door lock of claim 9, wherein the first section of the dog leg slot is parallel to the longitudinal axis and the second section of the dog leg slot is angled relative to the longitudinal axis.

11. The sliding door lock of claim 9, wherein the cam is rotatable between at least a first operating position whereby the at least one locking element is retracted and a second operating position whereby the at least one locking element is extended and longitudinally locked, and wherein about a third of the rotation of the cam is configured to move the at least one locking element towards the extended position and about two-thirds of the rotation of the cam is configured to slide the extended at least one locking element towards the longitudinally locked position.

12. The sliding door lock of claim 9, wherein the slide mechanism includes a channel elongated in a direction orthogonal to the longitudinal axis, the pin of the retractor disposed within the channel of the slide mechanism.

13. The sliding door lock of claim 12, wherein the channel is rectangular in shape.

14. The sliding door lock of claim 9, wherein the retractor is substantially T-shaped with the pin disposed in a base leg.

15. The sliding door lock of claim 9, wherein the retractor includes a biasing spring configured to bias the at least one locking element in the extended position.

16. The sliding door lock of claim 9, wherein the slide mechanism includes a threaded boss configured to extend at least partially from the housing.

17. A sliding door lock comprising:
a housing defining a dog leg slot;
a cam rotatably mounted in the housing and movable between at least a first operating position and a second operating position;
a slide mechanism adapted to linearly translate in the housing along a longitudinal axis, wherein the slide mechanism comprises a slot extending substantially orthogonal to the longitudinal axis;
a pin coupled to the cam and being slidably engaged with the slot of the slide mechanism, wherein rotation of the cam moves the slide mechanism between at least a first position and a second position;
at least one locking element coupled to the slide mechanism and adapted to move with the slide mechanism;
an overcenter spring for biasing the pin, wherein the force exerted on the pin by the overcenter spring forces the cam into both the first operating position and the second operating position; and
a retractor supported at least partially within the slide mechanism, the retractor includes a retractor pin that is slidably received at least partially within the dog leg slot of the housing, wherein when the slide mechanism moves between the first position and the second position via rotation of the cam, the retractor at least partially transversely slides relative to the slide mechanism via the retractor pin so as to move the at least one locking element between an extended locked configuration and a retracted unlocked configuration.

18. The sliding door lock of claim 17, wherein the slide mechanism includes a threaded boss.

19. The sliding door lock of claim 17, wherein the retractor further includes a bias spring supported on the retractor pin, the bias spring configured to allow the at least one locking element to depress when in the extended locked configuration and in an anti-slam configuration.

20. The sliding door lock of claim 17, wherein the at least one locking element includes a pair of locking elements.
